(19) United States
(12) Patent Application Publication
(10) Pub. No.: US 2025/0206312 A1
(43) Pub. Date: Jun. 26, 2025

(54) PARKING CONTROL DEVICE FOR VEHICLE

(71) Applicant: TOYOTA JIDOSHA KABUSHIKI KAISHA, Toyota-shi (JP)

(72) Inventors: Keiji KAITA, Miyoshi-shi (JP); Takahiko Hirasawa, Toyota-shi (JP)

(73) Assignee: TOYOTA JIDOSHA KABUSHIKI KAISHA, Toyota-shi (JP)

(21) Appl. No.: 18/918,090

(22) Filed: Oct. 17, 2024

(30) Foreign Application Priority Data
Dec. 22, 2023 (JP) 2023-217062

(51) Int. Cl. B60W 30/18; B60W 10/08; B60W 10/18; B60W 10/192; F16H 63/34

(52) U.S. Cl. CPC B60W 30/18109; B60W 10/08; B60W 10/182; B60W 10/192; F16H 63/3458; B60W 2510/08; B60W 2510/18; B60W 2510/186; B60W 2520/10; B60W 2540/227; B60W 2710/083; B60W 2710/18; B60W 2710/188

(57) ABSTRACT

An unmanned detection unit detecting that the driver is away from the driver's seat, a vehicle speed detection unit detecting the vehicle speed of the vehicle, a vehicle speed determination unit determining whether the vehicle speed detected by the vehicle speed detection unit in a state where the driver is detected by the unmanned detection unit in a state where the driver is away from the driver's seat of the vehicle is equal to or lower than a predetermined vehicle speed, a braking control unit executing braking control for reducing the vehicle speed by determining that the vehicle speed exceeds the predetermined vehicle speed in a state where the driver is away from the driver's seat of the vehicle, and a parking control unit executing parking control for operating the parking mechanism when the vehicle speed becomes equal to or lower than the predetermined vehicle speed after executing braking control.

### CROSS-REFERENCE TO RELATED APPLICATION

This application claims priority to Japanese Patent Application No. 2023-217062 filed on Dec. 22, 2023, incorporated herein by reference in its entirety.

### BACKGROUND

### 1. Technical Field

The present Disclosure relates to a device that performs a control to maintain a vehicle in a parking state.

### 2. Description of Related Art

A foot brake and a parking brake are known as devices to stop a vehicle. The foot brake is a brake that brakes a vehicle wheel by causing a frictional force to act on a brake drum or a brake disc integrated with the vehicle wheel, by having a driver press down a brake pedal. On the other hand, the parking brake is a brake that stops a rotation of the vehicle wheel by engaging a locking member with a predetermined rotation member coupled to the vehicle wheel, by having the driver operate a parking brake lever or a parking pedal, or by the driver operating a shift leaver to select a parking position. The parking brake is configured so that the driver can temporarily stop a rotation of the vehicle wheel if the parking operation is performed, and therefore the vehicle can be maintained in a stopped state (parking state) when the driver gets off.

The parking brake is a mechanism that is operated by being consciously operated by the driver. When the driver leaves the vehicle by confirming only that the vehicle has stopped, or when a parking brake lever is operated but the operation is insufficient, it is possible for the vehicle to move due to an inclination of a road surface. Accordingly, a device described in Japanese Unexamined Patent Application Publication (Translation of PCT Application) No. 2009-530156 (JP 2009-530156 A) is configured to operate a parking brake in place of a driver. Namely, the device described in JP 2009-530156 A is configured to operate the parking brake, based on detecting that a door on a driver's seat side is locked.

### SUMMARY

The device described in JP 2009-530156 A executes a control to operate the parking brake, or output a command signal that executes the control, with a condition that the door on the driver's seat side is locked and therefore the driver is leaving the driver's seat as a premise. Therefore, according to the device described in JP 2009-530156 A, a certain amount of time elapses while the driver leaves the driver's seat and gets off, and thereafter locks the door on the driver's seat side. During the time, a state continues in which the parking brake is not operated, and therefore there is a possibility that the vehicle moves due to an inclination of a road surface or the like, and reaches a vehicle speed equal to or higher than a predetermined vehicle speed. In such a case, if there is a parking mechanism with a configuration that stops a rotation of the vehicle wheel by engaging a locking member with a rotation member, the locking member is bounced back by the rotation member due to the rotation member rotating at a certain speed. The locking member does not engage with the rotation member. There is a possibility that a state occurs where a so-called parking lock cannot be performed.

While the device described in JP 2009-530156 A is configured to automatically perform an instruction that starts a control to set the vehicle in a parking state, the device is not configured to establish a parking state. There is a possibility that an unmanned vehicle starts to move. There is room for improvement by the point.

The present Disclosure has been made in view of the above circumstances, and the present Disclosure has an objective to provide a parking control device capable of reliably setting a vehicle in a parking state by positively using an electric motor that is a driving power source.

The present Disclosure, in order to achieve the objective, is
a parking control device for a vehicle that executes a parking control to operate a parking mechanism when a vehicle equipped with an electric motor as a driving power source is maintained in a stopped state, the parking control device including
a controller that executes the parking control, in which
the controller includes
an unmanned detection unit that detects a driver being away from a driver's seat of the vehicle,
a vehicle speed detection unit that detects a vehicle speed of the vehicle,
a vehicle speed determination unit that determines whether the vehicle speed detected by the vehicle speed detection unit is equal to or lower than a predetermined vehicle speed in a state where the driver being away from the driver's seat of the vehicle is detected by the unmanned detection unit,
a braking control unit that executes a braking control to reduce the vehicle speed by determining that the vehicle speed exceeds the predetermined vehicle speed by the vehicle speed determination unit in a state where the driver is away from the driver's seat of the vehicle, and
a parking control unit that executes a parking control to activate the parking mechanism by the vehicle speed being equal to or lower than the predetermined vehicle speed after the braking control is executed.

In the present Disclosure, the electric motor may be configured of a three-phase motor, and
the braking control unit may be configured to perform a three-phase ON control that turns ON each phase of the three-phase motor to output a torque in a direction that the vehicle speed is reduced.
   in the present Disclosure, the vehicle may further include an electric brake mechanism that is electrically controlled to generate a frictional force to stop rotation of a vehicle wheel, and
the braking control unit may be configured to operate the electric brake mechanism in conjunction with the three-phase ON control to reduce the vehicle speed.

In the present Disclosure, the braking control unit may be configured to reduce the vehicle speed by operation of the electric brake mechanism when a failure occurs in the three-phase ON control, and reduce the vehicle speed by the three-phase ON control when a failure occurs in the operation of the electric brake mechanism.
in the present Disclosure, the vehicle may further include an electric brake mechanism that is electrically controlled to generate a frictional force to stop rotation of a vehicle wheel, and
   when a failure occurs in the parking mechanism, the parking control unit may be configured to operate the electric brake mechanism to maintain the vehicle in a stopped state.

In the present Disclosure, the vehicle speed determination unit may further include a function to determine the vehicle is moving and the vehicle speed equal to or lower than the predetermined vehicle speed, and the parking control unit may be configured to execute a parking control to activate the parking mechanism when the vehicle speed determination unit determines that the vehicle is moving and the vehicle speed is equal to or lower than the predetermined vehicle speed.

According to the present Disclosure, the vehicle speed is detected in a state where the driver is away from the driver's seat, and if the vehicle speed is equal to or lower than a predetermined vehicle speed, the parking mechanism is operated. In this case, since the vehicle speed is reduced by executing the braking control, the parking mechanism can be reliably operated to stop the vehicle.

In particular, in the present Disclosure, since a torque is output in a direction that reduces the vehicle speed from the electric motor that is a driving power source, it becomes possible to quickly reduce the vehicle speed to operate the parking mechanism, by including a case where the electric brake mechanism is operated. Moreover, even when a failure occurs in a mechanism to brake such as an electric brake mechanism, the vehicle speed can be quickly reduced to establish a stopped state of the vehicle by the parking mechanism.

When the electric brake mechanism is included, if a failure occurs in the parking mechanism, the vehicle can be maintained in the parking state by the electric brake mechanism. In this case, since the vehicle speed is reduced by the three-phase ON control of the three-phase motor, an inconvenience can be avoided or suppressed in which an excessive load, such as excessive friction, is applied to the electric brake mechanism, or a durability for an excessive load is reduced.

In addition, if the vehicle speed is equal to or lower than the predetermined vehicle speed even when the vehicle is moving in a state where the driver is away from the driver's seat, parking control is performed to operate the parking mechanism, without performing three-phase ON control or braking by an electric brake mechanism or the like. Not only can the parking mechanism operate normally to maintain the vehicle in a stopped state, but also an inconvenience such as unnecessarily executing the braking control can be avoided.

### BRIEF DESCRIPTION OF THE DRAWINGS

Features, advantages, and technical and industrial significance of exemplary embodiments of the Disclosure will be described below with reference to the accompanying drawings, in which like signs denote like elements, and wherein:

FIG. 1 is a schematic diagram for explaining a configuration of an example of a vehicle according to an embodiment of the present Disclosure;

FIG. 2 is a partial schematic diagram for explaining an example of the parking mechanism;

FIG. 3 is a block diagram illustrating a functional configuration of a controller;

FIG. 4 is a circuit diagram for explaining the principle configuration of inverters, and is a circuit diagram for explaining the status of three-phase ON control;

FIG. 5 is a diagram showing the torques generated by the motor during three-phase ON control; and

FIG. 6 is a flowchart for explaining an example of control executed in the embodiment of the present Disclosure.

### DETAILED DESCRIPTION OF EMBODIMENTS

Embodiments of the present Disclosure will now be described with reference to the accompanying drawings. Note that the embodiments described below are merely examples of the implementation of the present Disclosure, and do not limit the present Disclosure.

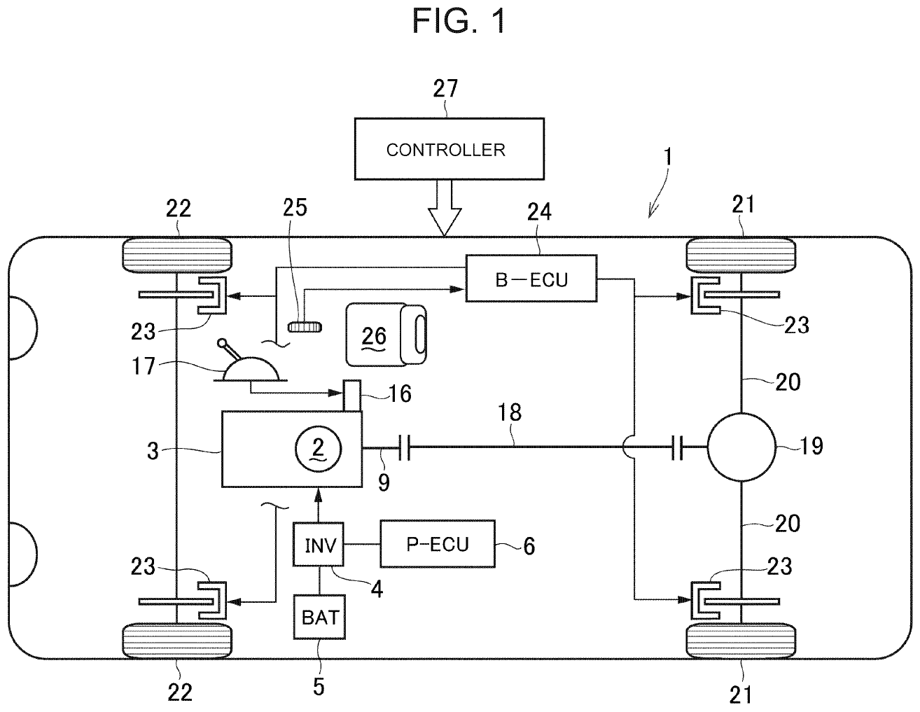

FIG. 1 schematically shows an example of a vehicle 1 subject to the present Disclosure Vehicle 1 subject to the present Disclosure is provided with an electric motor 2 in a driving force source 3. The electric motor 2 may independently constitute a driving force source, or may constitute a driving force source together with an internal combustion engine (not shown). Thus, the vehicle 1 may be battery electric vehicle (BEV) or hybrid electric vehicle (HEV, PHEV). The electric motor 2 may be a motor generator that generates electric power by being forcibly rotated by an external force in addition to a so-called motor that is supplied with electric power and outputs torque. Hereinafter, the electric motor 2 is simply referred to as a motor 2.

The motor 2 is, for example, a permanent magnet-type three-phase synchronous electric motor, and is connected to a power storage device (battery, BAT) 5 via an inverter (INV) 4. A power controller (P-ECU) 6 is connected to the inverter 4, and the power controller 6 controls the motor 2 via the inverter 4.

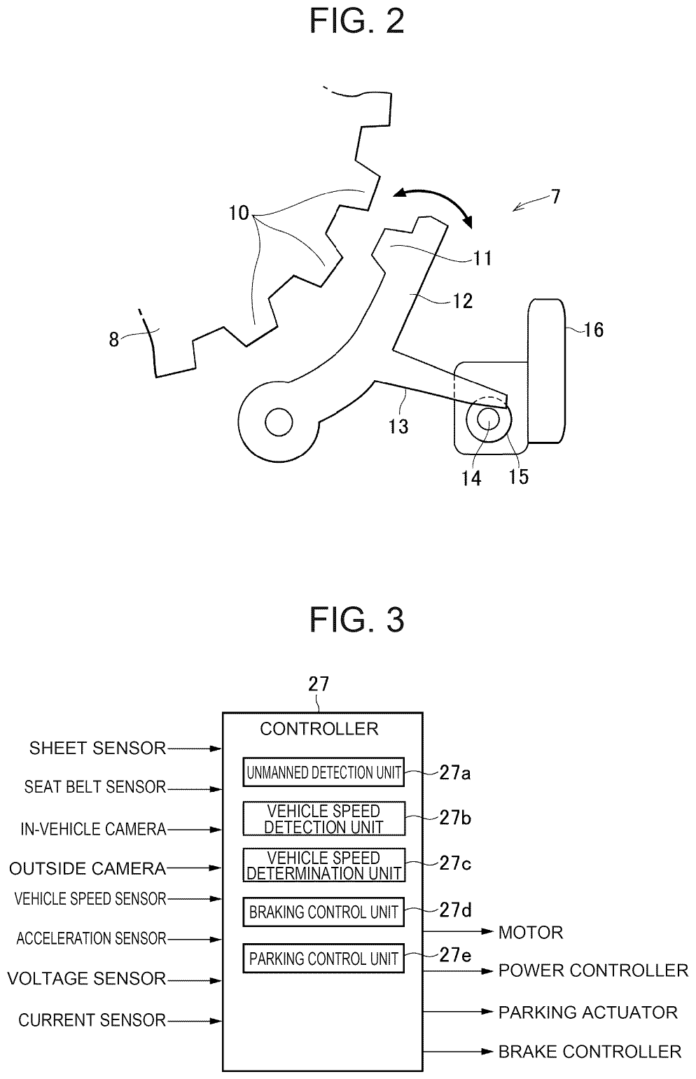

The driving force source 3 may include a transmission mechanism (not shown) such as a gear-type transmission mechanism or a speed reduction mechanism, and in this case, a parking mechanism is provided which meshes with a predetermined rotation member of the transmission mechanism and stops the rotation of the rotation member. FIG. 2 is a schematic diagram for explaining the configuration of the parking mechanism 7, and the rotation member 8 is connected to the output shaft 9 of the driving force source 3, and is configured to rotate integrally with the output shaft 9, and to stop the rotation of the output shaft 9 by fixing the rotation member 8. Teeth 10 are formed on an outer peripheral portion of the rotation member 8. A parking lock pole 12 having an engagement protrusion 11 that meshes with any one of the teeth 10 formed at a distal end portion thereof is disposed on the outer peripheral side of the rotation member 8. The parking lock pole 12 is supported so as to be rotatable about an axis parallel to the rotation center axis of the rotation member 8 at a proximal end portion opposite to the distal end portion where the engagement protrusion 11 is provided. That is, the parking lock pole 12 rotates such that the engagement protrusion 11 approaches and separates the teeth 10 of the rotation member 8.

In addition, the parking lock pole 12 has an arm portion 13 extending on the rear surface side thereof (the side opposite to the direction in which the engagement protrusion 11 protrudes). A parking lock rod 14 that is moved back and forth in a direction perpendicular to the arm portion 13 (a direction perpendicular to the plane of FIG. 2) is provided below the distal end portion of the arm portion 13 (a lower side in FIG. 2). The parking lock rod 14 is provided with a pointed head portion 15 having a conical (tapered) end portion, and the conical portion thereof is in contact with the lower surface of the arm portion 13. Furthermore, a parking lock actuator 16 is provided which is electrically controlled to move the parking lock rod 14 back and forth. When the parking lock actuator 16 advances the parking lock rod 14 and the pointed head portion 15 provided thereon, the arm portion 13 is pushed up toward the upper side in FIG. 2 by the pointed head portion 15. Accordingly, the parking lock pole 12 rotates in the counterclockwise direction in FIG. 2, and the engagement protrusion 11 provided at the distal end portion thereof meshes with the teeth 10 provided at the outer peripheral portion of the rotation member 8. As a result, the rotation of the rotation member 8 (that is, the output shaft 9) is stopped by the parking lock pole 12.

A lever 17 is provided for outputting a signal for activating the parking lock actuator 16 to a parking state. The lever 17 is a lever 17 that is manually operated when a driver (not shown) puts the vehicle 1 into a parking state, and may be, for example, a shift lever for a shift operation known in the art. A switch (not shown) that interlocks with the lever 17 is provided, and the switch is switched to, for example, a ON by operating the lever 17 to a parking position to output a signal. Note that the lever 17 may be replaced with a switch that is manually operated by ON/OFF. In addition, the parking lock actuator 16 is configured to be controllable by a controller which will be described later as well as a signal from a switch of this type. Note that the parking mechanism 7 may be a mechanism configured to stop the rotation of the rotation member 8 by a frictional force in addition to the above-described engagement type lock mechanism.

The output shaft 9 of the driving force source 3 is connected to a rear differential gear 19 which is a final reduction gear, for example, via a propeller shaft 18. The drive shafts 20 extending to the left and right of the rear differential gear 19 are connected to the rear wheels 21, which are drive wheels. A brake 23 is provided on each of the rear wheels 21 and the front wheels 22 in the same manner as a normal vehicle. The brake 23 is, for example, hydraulically actuated to generate a frictional force, and is configured to brake each of the rear wheel 21 and the front wheel 22 by the frictional force. A brake controller (B-ECU) 24 is provided to control the hydraulic pressure.

The brake controller 24 includes an electronic control unit mainly composed of a microcomputer, and various valves (not shown) as brake actuators that operate in response to a command signal from the electronic control unit to supply and discharge hydraulic pressure, regulate pressure, and the like. Therefore, the brake 23 corresponds to the electric brake mechanism in the embodiment of the present Disclosure. The brake 23 is a friction brake such as a drum brake or a disc brake, and is configured to continuously change a frictional force, that is, a braking force, in accordance with a hydraulic pressure. In the brake controller 24, an operation amount such as a depression amount or a depression force of the brake pedal 25 depressed by the driver is input as data. The brake controller 24 is configured to transmit a control signal from a controller to be described later, and the brake 23 is configured to be controlled by the controller without depending on the brake pedal 25.

In FIG. 1, reference numeral 26 denotes a driver's seat. When the driver is not seated in the driver's seat 26, a determination of “unmanned” is made, and when the driver is seated, a determination of “manned” is made.

A parking control device according to an embodiment of the present Disclosure includes a controller 27 that executes parking control for reliably stopping the vehicle 1 and bringing the vehicle into a parking state in the case of “unmanned”. The controller 27 is an electronic control unit mainly composed of a microcomputer like the power controller 6 and the brake controller 24 described above. The controller 27 performs an operation according to a predetermined program using the input data as well as data stored in advance. The controller 27 is configured to output a result of the calculation as a control command signal. The control command signal is output to the power controller 6, the brake controller 24, and the parking lock actuator 16 to brake the vehicle 1 and operate the parking mechanism 7.

The input data for the control is data detected by various sensors. These sensors are not particularly shown. Examples thereof are a seat sensor provided in the driver's seat 26, a seat belt sensor for the driver's seat 26, or an in-vehicle camera for obtaining an image of the driver's seat 26. These detect data for performing the above-described “unmanned” and “manned” determinations. Further, a vehicle speed sensor, an external camera, or an acceleration sensor is provided. These units detect data for determining that the vehicle 1 is moving or stopping or for determining whether the vehicle speed is equal to or lower than a predetermined vehicle speed. Further, a sensor for detecting an operation state of an electric system such as a voltage sensor or a current sensor is provided. The power controller 6, the parking lock actuator 16, the brake controller 24, and the other electric devices such as the motor 2 are powered ON. On the other hand, the data stored in advance is data serving as a criterion for determining “unmanned” or “manned”, determining the vehicle speed, determining ON of the power supply, and the like, a control quantity for performing feedforward control of the motor 2 or the brake 23, and the like.

The controller 27 in the embodiment of the present Disclosure is configured to perform parking control based on not only that the vehicle 1 is “unmanned” but also that the vehicle 1 is moving. The controller 27 is programmed to perform such parking control, and its function is shown in a block diagram in FIG. 3.

The controller 27 includes an unmanned detection unit 27a that detects that the driver is away from the driver's seat 26, i.e., is “unmanned”. If the vehicle 1 is equipped with a seat sensor or a seat belt sensor, it is possible to detect that the vehicle is “unmanned” because the sensor is OFF. Further, in the vehicle 1 provided with the in-vehicle camera, it is possible to detect that the driver (human) is “unmanned” due to the absence of the driver (human) in the image. Instead of the in-vehicle camera, it is also possible to detect that the camera is “unmanned” by an infrared sensor.

A vehicle speed detection unit 27b is provided in the controllers 27. The vehicle speed detection unit 27b may be configured to detect an absolute value of a moving speed of the vehicle 1, or may be configured to detect that the vehicle 1 is simply moving, or may be configured to detect both of them. Such detection can be performed based on data obtained by the vehicle speed sensor, image data obtained by the outside camera, and data obtained by the acceleration sensor.

A vehicle speed determination unit 27c that determines whether the vehicle speed obtained by the vehicle speed detection unit 27b is equal to or lower than a predetermined vehicle speed is provided in the controllers 27. the predetermined vehicle speed serving as a criterion for the determination is determined in advance by an experiment, a simulation, or the like as the maximum value of the vehicle speed (which can be P-locked) at which the parking lock pole 12 can be reliably engaged without being bounced back by the rotation member 8. the predetermined vehicle speed may be stored in advance in the controller 27.

The controllers 27 are provided with a braking control unit 27d that executes braking control for reducing the vehicle speed prior to operating the parking mechanism 7. The braking control is a control for lowering the vehicle speed to the predetermined vehicle speed or lower, and the key is a control for causing a torque in a direction in which the rotation is stopped to act on the rear wheel 21 or on the rear wheel 21 and the front wheel 22. Thus, the braking can be effected by generating a so-called negative torque by means of the motor 2, or in conjunction or alternatively by actuating the brake 23.

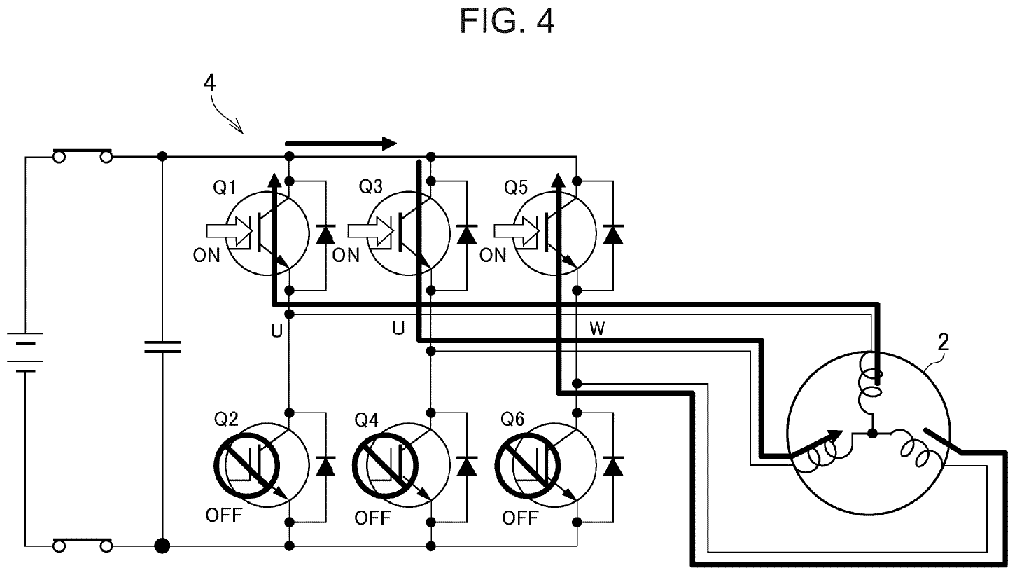

Here, an exemplary control for generating a so-called negative torque by the motor 2 is three-phase ON control. FIG. 4 schematically shows the principle configuration of the inverter 4. Three-phase ON control is a control for setting the upper switching element (IGBT) Q1, Q3, Q5 in FIG. 4 to ON and setting the lower switching element (IGBT) Q2, Q4, Q6 to OFF for each phase of U-phase and V-phase and W-phase. In this state, current flows as shown by the arrow in FIG. 4, also by the motor 2 rotates, the U-phase and V-phase and W-phase is switched.

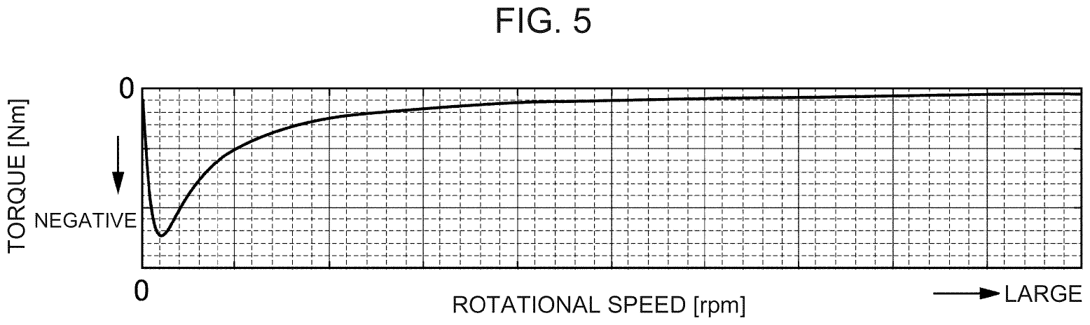

FIG. 5 shows an exemplary torque-generated state during three-phase ON control (three-phase short-circuit). As shown in FIG. 5, the motor 2 generates a negative torque, and its magnitude increases rapidly when it starts to rotate, and gradually decreases as the number of revolutions increases after the maximum value is reached. Therefore, the motor 2 can generate a relatively large braking force by performing the three-phase ON control in a low-speed condition in which the vehicle 1 is unmanned and has started to move due to a road slope or the like.

The controller 27 further includes a parking control unit 27e. When the predetermined condition is satisfied, the parking control unit 27e executes the parking control for operating the parking mechanism 7 to stop the rotation of the rotation member 8 (that is, the vehicle 1).

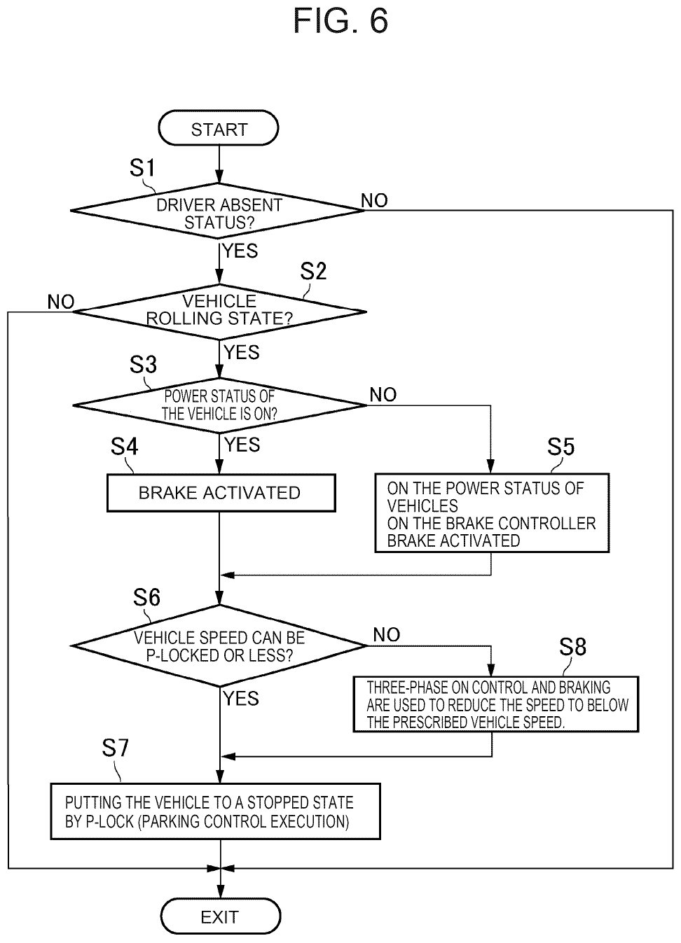

An example of the control executed by the controller 27 will be described with reference to a flowchart shown in FIG. 6. The routine illustrated in FIG. 6 is executed by the controllers 27 even in a state where the vehicle 1 is stopped and the power is turned OFF, and first, it is determined whether the driver is absent (S1). This determination determines whether the vehicle 1 is in the “unmanned” condition described above, and can be performed by the unmanned detection unit 27a described above.

If S1 determination is “no”, the routine of FIG. 6 is temporarily ended without performing any particular control. On the contrary, if S1 is determined to be “yes”, it is determined whether the vehicle is in a rolling condition (S2). The rolling state is a state in which the driving force source 3 is stopped and the “unmanned” vehicle 1 is moved by itself due to a slope of a road surface or the like, and therefore, in S2, it is determined whether the vehicle is moving. This determination can be made by the above-described vehicle speed detection unit 27b based on data obtained by a vehicle speed sensor, an external camera, an acceleration (G) sensor, or the like, as described above.

When S2 is determined to be “no”, the vehicle 1 is stopped, and thus the routine of FIG. 6 is temporarily ended without any particular control. On the contrary, when S2 is determined to be “yes”, it is determined whether the power supply of the vehicle 1 is ON (S3). This determination can be made based on data obtained by the voltage sensor or the current sensor described above.

If the determination of S3 is “yes”, the actuator generating the braking force is activated (S4). In the vehicle 1 having the configuration illustrated in FIG. 1, since the brake controller 24 is turned ON when the power is turned ON, the brake controller 24 operates the brake 23 to perform braking. In this case, the increase slope of the braking force and the increase slope of the braking force can be determined in advance in terms of design. On the other hand, when S3 determination is “no”, the power of the vehicle 1 is turned ON, the brake controller 24 is turned ON, and the brake 23 is activated by the brake controller 24 to perform braking (S5).

That is, if the “unmanned” vehicle 1 is moving, braking for decelerating the vehicle 1 is performed using the brake 23 anyway. The braking control in the control (S4, S5) is preferable for rapid parking control, but may be omitted in the present disclosure.

After the above S4 or S5, it is determined whether the vehicle speed is equal to or lower than the P-lockable vehicle speed (S6). The P-lockable vehicle speed corresponds to the predetermined vehicle speed in the embodiment of the present Disclosure. This is a vehicle speed corresponding to a rotational speed at which the rotational speed of the rotation member 8 in the parking mechanism 7 described above can cause meshing without bouncing back the engagement protrusion 11 of the parking lock pole 12. Therefore, the predetermined vehicle speed is generally several kilometers per hour. The determination of S6 can be performed by the vehicle speed determination unit 27c described above.

If the determination of S6 is “yes”, the parking mechanism 7 is activated (by P-locking) to S7 the vehicle 1. That is, the parking control is immediately executed without performing control for deceleration described later. Therefore, quick parking control becomes possible, and wear of the brake 23 and the like can be suppressed, and durability thereof can be improved.

In this case, the brake 23 is operated by the brake controller 24 when the parking mechanism 7 or the parking lock actuator 16 or the control device that controls it is experiencing some sort of failure and cannot execute the P-lock. This keeps the vehicle 1 in a parked state. Thereafter, the control of FIG. 6 is temporarily ended.

On the contrary, when S6 is determined to be “no”, the vehicle speed is decelerated to a predetermined vehicle speed or less (S8) by the braking control according to the three-phase ON control of the motor 2 and ON control of the brake 23, and thereafter, S7 proceeds. When the vehicle 1 is decelerated in this way, if the control of the brake 23 is malfunctioning due to some kind of failure, the vehicle 1 is decelerated only by the three-phase ON control of the motor 2. On the contrary, when the control of the motor 2 is malfunctioning due to a failure from whatever, the vehicle 1 is decelerated only by the brake 23.

By performing the control of lowering the vehicle speed to the predetermined vehicle speed or less by the three-phase ON control of the motor 2 and the brake 23, the vehicle speed can be rapidly lowered, and the subsequent stopping of the vehicle 1 by the parking mechanism 7 can be quickly performed. Further, the use frequency or load of the brake 23 can be reduced to improve the durability thereof. Furthermore, by simultaneously performing the three-phase ON control of the motor 2 and ON control of the brake 23, the vehicle I can be stopped even if a failure occurs in either one of them. The reliability of controlling the “unmanned” vehicle 1 to the parking state can be improved.

It should be noted that the present Disclosure is not limited to the above-described embodiments, and can be appropriately modified and implemented within the scope of achieving the object of the present Disclosure. For example, the parking mechanism according to the present Disclosure may be any mechanism capable of stably maintaining the vehicle in a stopped state. The parking mechanism may be a mechanism configured to move the friction material back and forth by the feed screw mechanism and maintain a locked state by the feed screw mechanism. In addition, the present disclosure may be configured to perform three-phase ON control or braking control by braking when the vehicle speed exceeds a predetermined vehicle speed. Therefore, the control (the control of S4, S5 described above) of operating the actuator that generates the braking force prior to determining whether the vehicle speed is equal to or lower than the predetermined vehicle speed is not essential. This control may be appropriately performed as necessary.

What is claimed is:

1. A parking control device for a vehicle that executes a parking control to operate a parking mechanism when a vehicle equipped with an electric motor as a driving power source is maintained in a stopped state, the parking control device comprising a controller that executes the parking control, wherein the controller includes
an unmanned detection unit that detects a driver being away from a driver's seat of the vehicle,
a vehicle speed detection unit that detects a vehicle speed of the vehicle,
a vehicle speed determination unit that determines whether the vehicle speed detected by the vehicle speed detection unit is equal to or lower than a predetermined vehicle speed in a state where the driver being away from the driver's seat of the vehicle is detected by the unmanned detection unit,
a braking control unit that executes a braking control to reduce the vehicle speed by determining that the vehicle speed exceeds the predetermined vehicle speed by the vehicle speed determination unit in a state where the driver is away from the driver's seat of the vehicle, and
a parking control unit that executes a parking control to activate the parking mechanism by the vehicle speed being equal to or lower than the predetermined vehicle speed after the braking control is executed.

2. The parking control device according to claim 1, wherein:
the electric motor is configured of a three-phase motor; and
the braking control unit is configured to perform a three-phase ON control that turns ON each phase of the three-phase motor to output a torque in a direction that the vehicle speed is reduced.

3. The parking control device according to claim 2, wherein:
the vehicle further includes an electric brake mechanism that is electrically controlled to generate a frictional force to stop rotation of a vehicle wheel; and
the braking control unit is configured to operate the electric brake mechanism in conjunction with the three-phase ON control to reduce the vehicle speed.

4. The parking control device according to claim 3, wherein the braking control unit is configured to reduce the vehicle speed by operation of the electric brake mechanism when a failure occurs in the three-phase ON control, and reduce the vehicle speed by the three-phase ON control when a failure occurs in the operation of the electric brake mechanism.

5. The parking control device according to claim 2, wherein:
the vehicle further includes an electric brake mechanism that is electrically controlled to generate a frictional force to stop rotation of a vehicle wheel; and
the parking control unit is configured to operate the electric brake mechanism to maintain the vehicle in a stopped state when a failure occurs in the parking mechanism.

6. The parking control device according to claim 1, wherein:
the vehicle speed determination unit further includes a function to determine the vehicle is moving and the vehicle speed equal to or lower than the predetermined vehicle speed; and
the parking control unit is configured to execute a parking control to activate the parking mechanism when the vehicle speed determination unit determines that the vehicle is moving and the vehicle speed is equal to or lower than the predetermined vehicle speed.
